(19) United States
(12) Patent Application Publication
(10) Pub. No.: US 2020/0349425 A1
(43) Pub. Date: Nov. 5, 2020

(54) TRAINING TIME REDUCTION IN AUTOMATIC DATA AUGMENTATION

(71) Applicant: FUJITSU LIMITED, Kawasaki-shi (JP)

(72) Inventors: Ripon K. SAHA, Santa Clara, CA (US); Xiang GAO, Santa Clara, CA (US); Mukul R. PRASAD, San Jose, CA (US); Indradeep GHOSH, Cupertino, CA (US)

(73) Assignee: FUJITSU LIMITED, Kawasaki-shi (JP)

(21) Appl. No.: 16/399,399

(22) Filed: Apr. 30, 2019

(51) Int. Cl. G06N 3/08; G06N 3/04

(52) U.S. Cl. CPC G06N 3/08; G06N 3/04

(57) ABSTRACT

A method may include obtaining a deep neural network model and obtaining a first training data point and a second training data point for the deep neural network model during a first training epoch. The method may include determining a first robustness value of the first training data point and a second robustness value of the second training data point. The method may further include omitting augmenting the first training data point in response to the first robustness value satisfying a robustness threshold and augmenting the second training data point in response to the second robustness value failing to satisfy the robustness threshold. The method may also include training the deep neural network model on the first training data point and the augmented second training data point during the first training epoch.

### FIELD

The embodiments discussed in the present disclosure are related to Deep Neural Networks and systems and methods of reducing the training time thereof.

### BACKGROUND

Deep Neural Networks (DNNs) are increasingly being used in a variety of applications. However DNNs may be vulnerable to noise in the input. More specifically, even a small amount of noise injected into the input of the DNN can result in a DNN, which is otherwise considered to be high-accuracy, returning inaccurate predictions. Augmenting the training data set to improve the accuracy of the DNN in the face of noise may increase the time it takes to train the DNN.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

A method may include obtaining a deep neural network model and obtaining a first training data point and a second training data point for the deep neural network model during a first training epoch. The method may include determining a first robustness value of the first training data point and a second robustness value of the second training data point. The method may further include omitting augmenting the first training data point in response to the first robustness value satisfying a robustness threshold and augmenting the second training data point in response to the second robustness value failing to satisfy the robustness threshold. The method may also include training the deep neural network model on the first training data point and the augmented second training data point during the first training epoch.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram representing an example environment related to reducing the training time of a Deep Neural Network (DNN) model;

FIG. 2 is a conceptual illustration of the difference between a robustness and an accuracy of a DNN model;

FIG. 3 is an illustration of reducing training time of a DNN model;

FIG. 4 is a table that illustrates reducing training time of a DNN model;

FIG. 5 is a flowchart of a first example method of determining a robustness of a training data point;

FIG. 6 is a flowchart of a second example method of determining a robustness of a training data point;

FIG. 7 is a flowchart of an example method of training a DNN;

FIG. 8 is a flowchart of an example method of reducing the training time of a DNN; and

FIG. 9 illustrates an example computing system that may be configured to evaluate the robustness of a DNN model.

### DESCRIPTION OF EMBODIMENTS

Some embodiments described in the present disclosure relate to methods and systems of measuring the robustness of Deep Neural Networks (DNNs). A DNN is an artificial neural network (ANN) which generally includes an input layer and an output layer with multiple layers between the input and output layers. As the number of layers between the input and output increases, the depth of the neural network increases and the performance of the neural network is improved.

The DNN may receive inputs, which may include images, audio, text, or other data, and may perform a prediction as to a classification of the input or a prediction as to an expected behavior based on the input. For example, when the inputs are images, possible outputs of the DNN may include a classification of the images (such as, for example, “dog” image, “cat” image, “person” image, etc.) or an expected behavior (such as, for example, stopping a vehicle when the input is determined to be a red light at a stoplight). Alternatively, when the inputs are audio, possible outputs of the DNN may include classification of the audio (such as, for example, identification of words in the audio, identification of a source of the audio (e.g., a particular animal or a particular person), identification of an emotion expressed in the audio). As part of training the DNN, a set of labeled inputs may be provided, i.e. a set of inputs along with the corresponding outputs, so that the DNN may learn to identify and classify many different inputs.

The DNN may find a specific mathematical manipulation to turn the input into the output, whether it be a linear relationship or a non-linear relationship. The network moves through the layers calculating the probability of each output. Each mathematical manipulation as such is considered a layer, and complex DNNs have many layers, hence the name “deep” networks.

Deep Neural Networks (DNNs) are increasingly being used in a variety of applications. Examples of a few fields of application include autonomous driving, medical diagnostics, malware detection, image recognition, visual art processing, natural language processing, drug discovery and toxicology, recommendation systems, mobile advertising, image restoration, and fraud detection. Despite the recent popularity and clear utility of DNNs in a vast array of different technological areas, in some instances DNNs may be vulnerable to noise in the input, which can result in inaccurate predictions and erroneous outputs. In the normal operation of a DNN, a small amount of noise can cause small perturbations in the output, such as an object recognition system mischaracterizing a lightly colored sweater as a diaper, but in other instances, these inaccurate predictions can result in significant errors, such as an autonomous automobile mischaracterizing a school bus as an ostrich.

In order to create a DNN that is more resilient to such noise and results in fewer inaccurate predictions, an improved system of adversarial testing with an improved ability to find example inputs that result in inaccurate predictions, which may cause the DNN to fail or to be unacceptably inaccurate, is disclosed. One benefit of finding such example inputs may be the ability to successfully gauge the reliability of a DNN. Another benefit may be the ability to use the example inputs that result in inaccurate predictions to “re-train” or improve the DNN so that the inaccurate predictions are corrected.

To improve the resilience of the DNN to noise, training data points used to train the DNN may be augmented with variants of the training data points. For example, natural variants of training data points, such as, for example, rotations of images, may be added to the training set to improve the ability of the DNN to classify inputs. The process of augmented training data points with variants may improve the accuracy of the DNN. Data augmentation may include augmenting each training data point with a random variant of the training data point, which may result in slight increases in the training time of the DNN along with slight improvements in accuracy of the DNN. Alternatively, many variants of each training data point may be added to the training data to augment the training data. However, adding additional augmentations of training data may be slow and may at times not increase the accuracy of the DNN.

Identifying training data points that are determined to be robust with respect to having correct outputs provided from variants of the training data points may reduce the increases in training time of the DNN while reducing sacrifices in DNN accuracy. For example, for some DNNs and some training data points, the DNN may accurately classify variants of the training data points without training the DNN on the training data points. In this scenario, augmenting the training data set with variants of the training data points may not improve the accuracy of the DNN and may increase the training time of the DNN. By identifying training data points as being robust when the DNN correctly classifies variants of the training data points, only particular training data points may be augmented and the DNN may have both improved accuracy and reduced training time.

Embodiments of the present disclosure are explained with reference to the accompanying drawings.

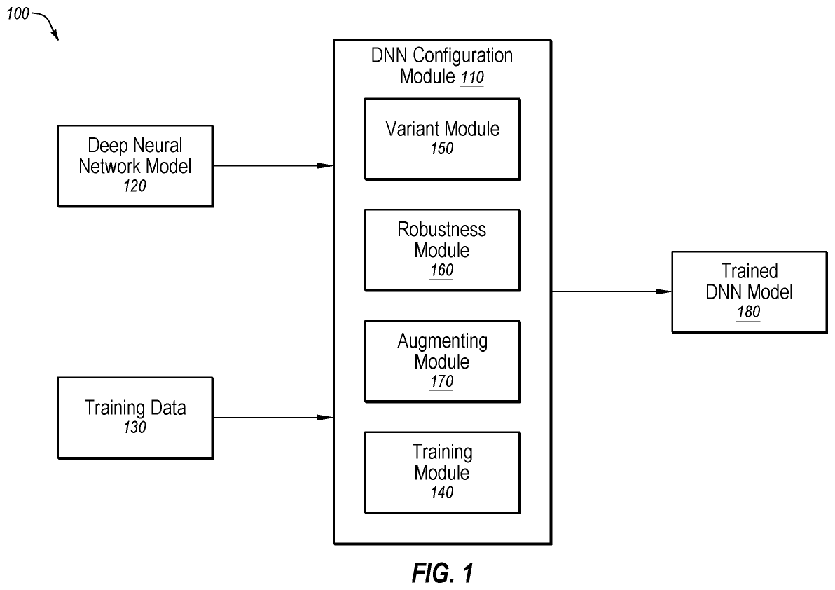

FIG. 1 is a diagram representing an example environment 100 related to reducing training time of a DNN model, arranged in accordance with at least one embodiment described in the present disclosure. The environment 100 may include a deep neural network model 120, training data 130, a DNN configuration module 110 including a training module 140, a variant module 150, a robustness module 160, and an augmenting module 170, and a trained DNN model 180.

In some embodiments, the deep neural network model 120 may include an input layer and an output layer with multiple layers between the input and output layers. Each layer may correspond with a mathematical manipulation to transform the input into the output. Training data, such as the training data 130, may enable the layers to accurately transform the input data into the output data.

In some embodiments, the training data 130 may include multiple training data points. Each of the training data points may include an item to be classified and a correct classification for the item. For example, in some embodiments, the deep neural network model 130 may be an image classification model. In these and other embodiments, the training data 130 may include multiple images and each image may be associated with a classification. For example, images of animals may be classified as “animal” while other images may be classified as “non-animal.” Alternatively or additionally, in some embodiments, images of particular kinds of animals may be classified differently. For example, images of cats may be classified as “cat” while images of dogs may be classified as “dog.” Alternatively or additionally, other classifications are possible. For example, the classifications may include “automobile,” “bicycle,” “person,” “building,” or any other classification.

In some embodiments, the deep neural network model 130 may be an audio classification model. In these and other embodiments, the training data 130 may include multiple audio files and each audio file may be associated with a classification. For example, the audio files may include human speech. In these and other embodiments, the classifications may include emotions of the speaker of the human speech, such as happy, sad, frustrated, angry, surprised, and/or confused. Alternatively or additionally, in some embodiments, the classifications may include particular words included in the speech, topics of conversation included in the speech, or other characteristics of the speech.

In some embodiments, the trained DNN model 180 may include the deep neural network model 120 after it has been trained on the training data 130 and/or other data. In these and other embodiments, the trained DNN model 180 may include appropriate model parameters and mathematical manipulations determined based on the neural network model 120, the training data 130, and augmented training data.

In some embodiments the DNN configuration module 110 may include code and routines configured to enable a computing system to perform one or more operations to generate one or more trained DNN models. Additionally or alternatively, the DNN configuration module 110 may be implemented using hardware including a processor, a microprocessor (e.g., to perform or control performance of one or more operations), a field-programmable gate array (FPGA), or an application-specific integrated circuit (ASIC). In some other instances, the DNN configuration module 110 may be implemented using a combination of hardware and software. In the present disclosure, operations described as being performed by the DNN configuration module 110 may include operations that the DNN configuration module 110 may direct a system to perform.

In some embodiments, the DNN configuration module 110 may be configured to obtain a deep neural network model 120 and training data 130 and to generate a trained DNN model 180. In these and other embodiments, the DNN configuration module 110 may include a training module 140, a variant module 150, a robustness module 160, and an augmenting module 170. The DNN configuration module 110 may direct the operation of the training module 140, the variant module 150, the robustness module 160, and the augmenting module 170 to selectively augment training data points of the training data 130 to generate the trained DNN model 180. In these and other embodiments, some training data points of the training data 130 may be determined to be robust and may not be augmented with variants of the training data points. In these and other embodiments, some training data points of the training data 130 may be determined to be not robust and may be augmented with variants of the training data points. After training the deep neural network model 120 with the training data 130 and augmented training data, the DNN configuration module 110 may generate the trained DNN model 180.

In some embodiments the variant module 150 may include code and routines configured to enable a computing system to perform one or more operations to generate one or more variants of the training data. Additionally or alternatively, the variant module 150 may be implemented using hardware including a processor, a microprocessor (e.g., to perform or control performance of one or more operations), a field-programmable gate array (FPGA), or an application-specific integrated circuit (ASIC). In some other instances, the variant module 150 may be implemented using a combination of hardware and software. In the present disclosure, operations described as being performed by the variant module 150 may include operations that the variant module 150 may direct a system to perform.

In some embodiments, the variant module 150 may generate multiple variants of the training data 130. For example, in some embodiments, the variant module 150 may randomly generate variants of each training data point in the training data 130. When the training data 130 includes visual data such as, for example, images and/or video, the variant module 150 may generate visual variants of the training data 130. The visual variants may include rotations of the training data (e.g., a 1° clockwise rotation of a training data point), translations of the training data (e.g., a five pixel shift to the right of a training data point), a shearing of the training data (e.g., shifting one portion of the training data point relative to another portion), zooming of the training data (e.g. expanding one portion of the training data point), changing a brightness of the first training data point (e.g. making parts and/or all of the training data point lighter), changing a contrast of the first training data point (e.g. reducing a color variation between portions of the training data point), and/or other variations of a training data point.

When the training data 130 includes audio data such as sounds, speech, and/or music, the variant module 150 may generate audio variants of the training data 130. The audio variants may include speed-based perturbations of speech in the training data, adding background noise to the training data, tempo-based perturbations of the training data, and/or other variations of a training data point.

In some embodiments, the variant module 150 may generate multiple variants of each data point in the training data. For example, in some embodiments, the variant module 150 may randomly generate a rotation, a translation, a shearing, a zooming, a changing of the brightness, and a changing of the contrast of the training data.

In some embodiments the robustness module 160 may include code and routines configured to enable a computing system to perform one or more operations to determine a robustness of the training data. Additionally or alternatively, the robustness module 160 may be implemented using hardware including a processor, a microprocessor (e.g., to perform or control performance of one or more operations), a field-programmable gate array (FPGA), or an application-specific integrated circuit (ASIC). In some other instances, the robustness module 160 may be implemented using a combination of hardware and software. In the present disclosure, operations described as being performed by the robustness module 160 may include operations that the robustness module 160 may direct a system to perform.

In some embodiments, the robustness module 160 may be configured to determine a robustness value of each data point in the training data 130 and compare the robustness values to a robustness threshold. In these and other embodiments, “robustness” may represent the ability of the deep neural network model 120 to correctly classify variants of the training data 130 generated by the variant module 150. For example, in some embodiments, the robustness module 160 may determine the robustness value for a data point as a quantity of variants of the data point that are classified correctly by the deep neural network model. For example, in some embodiments, the robustness threshold may be eighty-five and the variant module 150 may generate one hundred variants of a training data point and may provide the one-hundred variants to the robustness module 160. The robustness module 160 may provide the variants to the deep neural network model 120. The deep neural network model 120 may correctly classify eighty-seven of the variants. The robustness module 160 may determine the robustness value for the training data point is eighty-seven and because the robustness value exceeds the robustness threshold, the robustness module 160 may determine the training data point as being robust.

Alternatively or additionally, in some embodiments, the robustness module 160 may determine the robustness value for a data point as a loss for each variant of the training data point. In these and other embodiments, the robustness module 160 may determine the loss for a variant based on a confidence that the deep neural network model 120 correctly classifies the variant. For example, the deep neural network model 120 may correctly classify the variant with a confidence of 84%. The loss for the variant may be determined to be 100%−84%=16%. In these and other embodiments, the robustness module 160 may determine the robustness value for the data point to be the maximum loss of the losses associated with the variants of the training data point. In some embodiments, the robustness threshold may be 15%. The robustness module 160 may determine the robustness value for the training data point is 16% and because the robustness value exceeds the robustness threshold, the robustness module 160 may determine the training data point as being not robust.

In some embodiments, the robustness module 160 may not determine the robustness of a training data point for a particular number of epochs after the training data point is determined as being robust. For example, the robustness module 160 may not determine the robustness of the training data point during the next two epochs, during all training epochs following the robustness module 160 determining the training data point as being robust, or any other interval. As an additional example, in some embodiments, the robustness module 160 may determine a training data point as being robust during a fourth training epoch. Because the training data point was determined as being robust during the fourth training epoch, the robustness module 160 may not determine the robustness of the training data point during the following five epochs.

In some embodiments the augmenting module 170 may include code and routines configured to enable a computing system to perform one or more operations to augment the training data with one or more variants of the training data. Additionally or alternatively, the augmenting module 170 may be implemented using hardware including a processor, a microprocessor (e.g., to perform or control performance of one or more operations), a field-programmable gate array (FPGA), or an application-specific integrated circuit (ASIC). In some other instances, the augmenting module 170 may be implemented using a combination of hardware and software. In the present disclosure, operations described as being performed by the augmenting module 170 may include operations that the augmenting module 170 may direct a system to perform.

In some embodiments, the augmenting module 170 may augment the training data points of the training data 130 with one or more variants of the training data points. In some embodiments, the augmenting module 170 may augment training data points that are determined by the robustness module 160 as being not robust and may not augment training data points that are determined by the robustness module 160 as being robust. In these and other embodiments, the augmenting module 170 may augment the training data points with a subset of the variants generated by the variant module 150 and used by the robustness module 160 to determine the training data points as being robust. For example, in some embodiments, the variant module 150 may generate fifty, one hundred, one thousand, or another number of variants for the robustness module 160. In these and other embodiments, the augmenting module 170 may augment the training data points that are determined as being not robust with one, two, five, or another number of variants of the training data points.

In some embodiments the training module 140 may include code and routines configured to enable a computing system to perform one or more operations to train the deep neural network model 120 using the training data 130 and the augmented training data. Additionally or alternatively, the training module 140 may be implemented using hardware including a processor, a microprocessor (e.g., to perform or control performance of one or more operations), a field-programmable gate array (FPGA), or an application-specific integrated circuit (ASIC). In some other instances, the training module 140 may be implemented using a combination of hardware and software. In the present disclosure, operations described as being performed by the training module 140 may include operations that the training module 140 may direct a system to perform.

In some embodiments, the training module 140 may train the deep neural network model 120 using the training data 130 and the augmented training data from the augmenting module 170. For example, the training module 140 may iteratively train the deep neural network model 120 on the training data 130 and the augmented training data over the course of multiple training epochs. During each training epoch, the training module 140 may perform a forward propagation and a backward propagation over the training data 130 and the augmented training data to determine appropriate model parameters. In these and other embodiments, the training module 140 may train the deep neural network model 120 using an algorithm to minimize a cross-entropy loss function over the training data 130 and augmented training data. In some embodiments, some of the training data 130 may not be augmented during some training epochs. For example, during some training epochs, one or more training data points of the training data 130 may be determined by the robustness module 160 as being robust. Because the training data points are determined as being robust, the augmenting module 170 may not augment the training data points. The training module 140 may then train the deep neural network model 120 using the training data points without augmentation. After the training module 140 has completed training the deep neural network model 120 over the course of multiple training epochs, the result may be the trained DNN model 180.

A description of the operation of environment 100 follows. A DNN configuration module 110 may obtain a deep neural network model 120 and training data 130 for the deep neural network model 120. The DNN may provide the deep neural network model 120 and the training data 130 to the training module 140, variant module 150, robustness module 160, and augmenting module 170. During a first training epoch, the training module 140 may train the deep neural network model 120 on the training data 130 to generate model parameters. During subsequent training epochs, the variant module 150 may provide the robustness module 160 with variants of the training data 130 and the robustness module 160 may determine whether each training data point of the training data 130 is being robust or is being not robust. In response to a training data point of the training data 130 being determines as being not robust, the augmenting module 170 may augment the training data point with one or more variants of the training data point. The training module 140 may then train the deep neural network model 120 using the training data 130 and any augmented training data points. After the training module 140 has trained the deep neural network model 120, a trained DNN model 180 may be generated.

In some embodiments, the variant module 150 may be configured to not generate variants of training data points determined in a previous training epoch as being robust. In these and other embodiments, the robustness module 160 may be similarly configured to not determine the robustness of training data points determined in a previous training epoch as being robust. In this manner, the environment 100 may preferentially select training data points for augmentation when the augmentation is more likely to improve the accuracy of the trained deep neural network model 120. By selecting particular training data points for augmentation in the manner disclosed, the time to train the deep neural network model 120 may be reduced, improving the efficiency of using the deep neural network model 120 while maintaining and/or improving the accuracy of the trained deep neural network model 120.

Modifications, additions, or omissions may be made to FIG. 1 without departing from the scope of the present disclosure. For example, the environment 100 may include more or fewer elements than those illustrated and described in the present disclosure. Moreover, although described separately, in some embodiments, two or more of the training module 140, the variant module 150, the robustness module 160, and the augmenting module 170 may be part of a same system or divided differently than described. The delineation between these and other elements in the description is not limiting and is meant to aid in understanding and explanation of the concepts and principles used in the present disclosure. Alternatively or additionally, in some embodiments, one or more of the DNN configuration module 110, the variant module 150, the robustness module 160, the augmenting module 170, and the training module 140 may be distributed across different systems. In these and other embodiments, the environment 100 may include a network and one or more of the DNN configuration module 110, the variant module 150, the robustness module 160, the augmenting module 170, and the training module 140 may be communicatively coupled via the network.

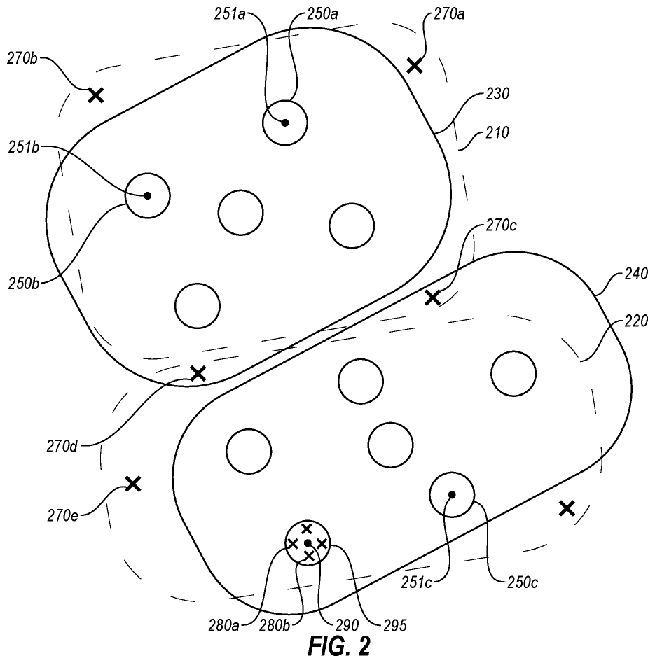

FIG. 2 is a conceptual illustration of robustness. As is illustrated in FIG. 2, for a first class 210 and a second class 220, a deep neural network model (e.g., the deep neural network model 120 of FIG. 1) may generate a pair of predicted classes, including a first predicted class 230 and a second predicted class 240, which are an attempt by the deep neural network model 120 to accurately predict a series of outcomes for the first class 210 and second class 220. Typically, the deep neural network model develops the first predicted class 230 and second predicted class 240 by utilizing a series of training data points 251a-251c. Generally, the accuracy of a deep neural network model is based on its ability to minimize adversarial instances or misclassifications, such as the points 270a-270e, which are found in the areas where the first predicted class 230 and second predicted class 240 do not accurately predict the scope of the first class 210 and second class 220, respectively.

Because the training data points 251a-251c are used to develop the deep neural network model, there is an expectation that the deep neural network model will be highly accurate at points near or within a predetermined distance to those training data points 251a-251c. In this illustration, the areas within a predetermined distance to those training data points 251a-251c are referred to as areas 250a-250c of training data points 251a-251c. In reality, however, often the deep neural network model may fail within an area of a training data point. For example, in the conception illustrated in FIG. 2, despite the accuracy of training data point 290, the deep neural network model may inaccurately predict results for points 280a-280b, which are within the area 295 of the training data point 290.

Augmentation may improve the accuracy of the deep neural network model at points near or within a predetermined distance to training data points 251a-251c. In some embodiments, points within the predetermined distance to the training data points 251a-251c may be variants of the training data points. For example, in some embodiments, points 280a-280b may be variants of training data point 290. In these and other embodiments, a DNN configuration module, such as the DNN configuration module 110 of FIG. 1, may be configured to augment the training data point 290 with one or more of the variants 280a-280b. In these and other embodiments, augmenting the training data point 290 with one or more of the variants 280a-280b may help the deep neural network model correctly predict results for the variants 280a-280b. Thus, augmenting the training data points with variants of the training data points may improve the problems illustrated in FIG. 2.

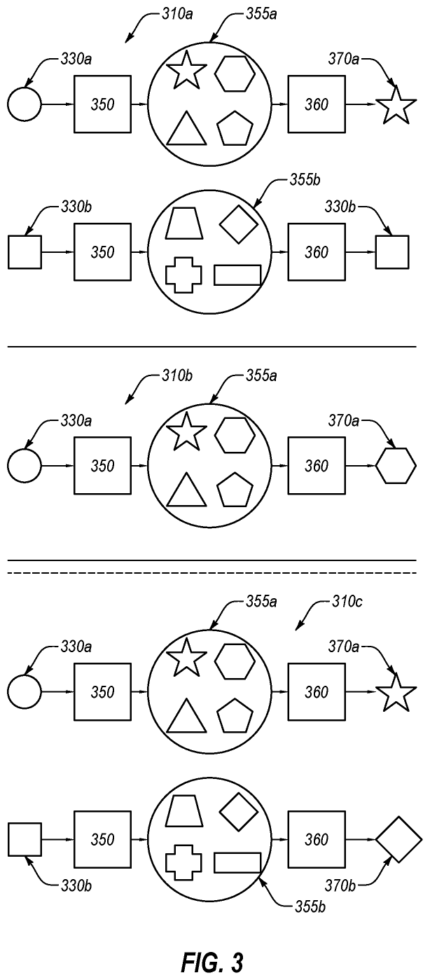

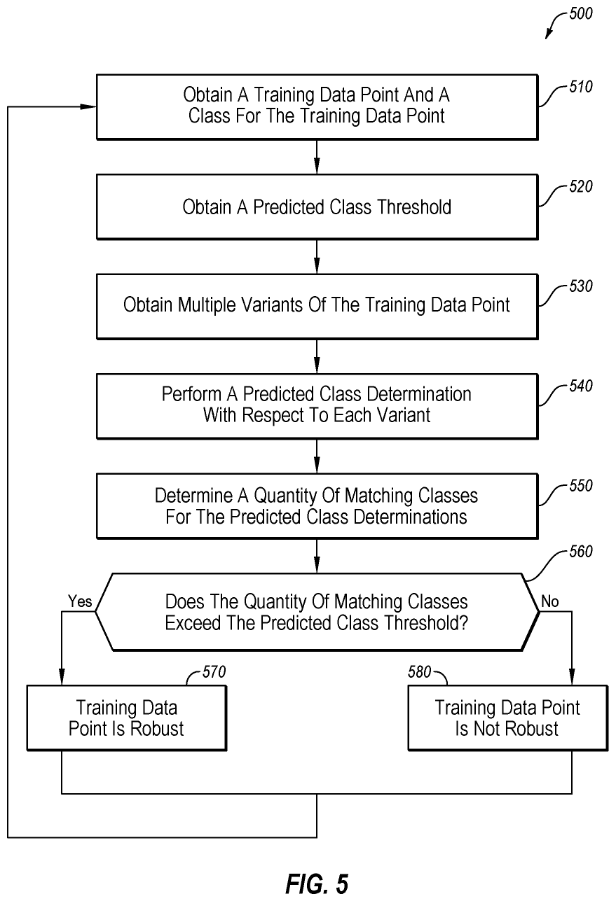

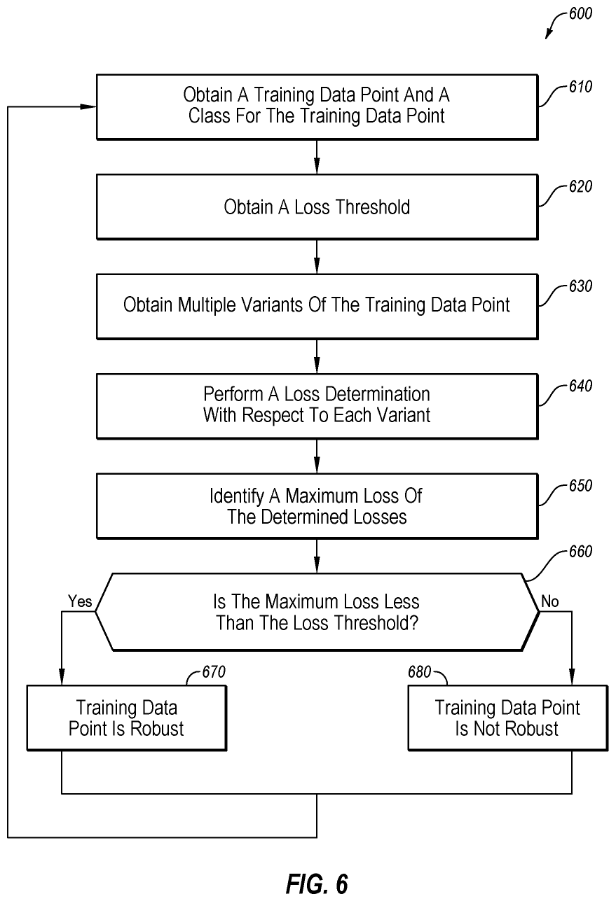

FIG. 3 is an illustration of reducing training time of a DNN model. The illustration 300 may be divided into a first training epoch 310a, a second training epoch 310b occurring immediately after the first training epoch 310a, and a third training epoch 310c occurring at least one training epoch after the second training epoch 310b. The illustration 300 may also include a first training data point 330a and a second training data point 330b. During the first training epoch 310a, a variant module 350, such as the variant module 150 of FIG. 1, may generate multiple variants 355a of the first training data point 330a and multiple variants 355b of the second training data point 330b. A robustness module 360, such as the robustness module 160 of FIG. 1, may determine whether the first training data point 330a and the second training data point 330b are being robust in a manner similar to that described above with reference to FIG. 1 or described below with reference to FIGS. 5 and 6. The robustness module 360 may determine first training data point 330a as being not robust during the first training epoch 310a and may determine the second training data point 330b as being robust during the first training epoch 310a. Because the first training data point 330a is determined as being not robust, an augmenting module, such as the augmenting module 170 of FIG. 1, may select a variant of the first training data point 330a from the multiple variants 355a and may augment the first training data point 330a with the variant 370a. Because the second training data point 330b is determined as being robust, the augmenting module may not select any variants of the second training data point 330b.

During the second training epoch 310b, the variant module 350 may generate multiple variants 355a of the first training data point 330a. In some embodiments, the multiple variants 355a of the first training data point 330a generated during the second training epoch 310b may be different from the multiple training variants 355a generated during the first training epoch 310a. Alternatively, in some embodiments, the variant module 350 may generate the same multiple variants 355a during both the first training epoch 310a and the second training epoch 310b. In some embodiments, the variant module 350 may not generate variants of the second training data point 330b during the second training epoch 310b because the robustness module 360 determined the second training data point 330b as being robust during the first training epoch 310a. In some embodiments, the robustness module 360 may determine the first training data point 330a as being not robust during the second training epoch 310b. Because the first training data point 330a is determined as being not robust, the augmenting module may select a variant of the first training data point 330a from the multiple variants 355a and may augment the first training data point 330a with the variant 370a. In some embodiments, the augmenting module may select a different variant 370a of the first training data point 330a to augment the first training data point 330a in the second training epoch 310b than was selected during the first training epoch 310a. Alternatively, in some embodiments, the augmenting module may select the same variant 370a of the first training data point 330a in the second training epoch 310b and the first training epoch 310a.

During the third training epoch 310c, the variant module 350 may generate multiple variants 355a of the first training data point 330a and multiple variants 355b of the second training data point 330b. In some embodiments, the multiple variants 355a of the first training data point 330a generated during the third training epoch 310c may be different from the multiple training variants 355a generated during the first training epoch 310a and/or the second training epoch 310b. Alternatively, in some embodiments, the variant module 350 may generate the same multiple variants 355a during the first training epoch 310a, the second training epoch 310b, and the third training epoch 310c. In some embodiments, the multiple variants 355b of the second training data point 330b generated during the third training epoch 310c may be different from the multiple training variants 355b generated during the first training epoch 310a. Alternatively, in some embodiments, the variant module 350 may generate the same multiple variants 355b during both the first training epoch 310a and the third training epoch 310c.

In some embodiments, the robustness module 360 may determine the first training data point 330a and the second training data point 330b as being not robust during the third training epoch 310c. Because the first training data point 330a is determined as being not robust, the augmenting module may select a variant of the first training data point 330a from the multiple variants 355a and may augment the first training data point 330a with the variant 370a. In some embodiments, the augmenting module may select a different variant 370a of the first training data point 330a to augment the first training data point 330a in the third training epoch 310c than was selected during the first training epoch 310a and/or the second training epoch 310b. Alternatively, in some embodiments, the augmenting module may select the same variant 370a of the first training data point 330a in the first training epoch 310a, the second training epoch 310b, and the third training epoch 310c. Because the second training data point 330b is determined as being not robust, the augmenting module may select a variant of the second training data point 330b from the multiple variants 355b and may augment the second training data point 330b with the variant 370b.

Modifications, additions, or omissions may be made to FIG. 3 without departing from the scope of the present disclosure. For example, the illustration 300 may include more or fewer elements than those illustrated and described in the present disclosure.

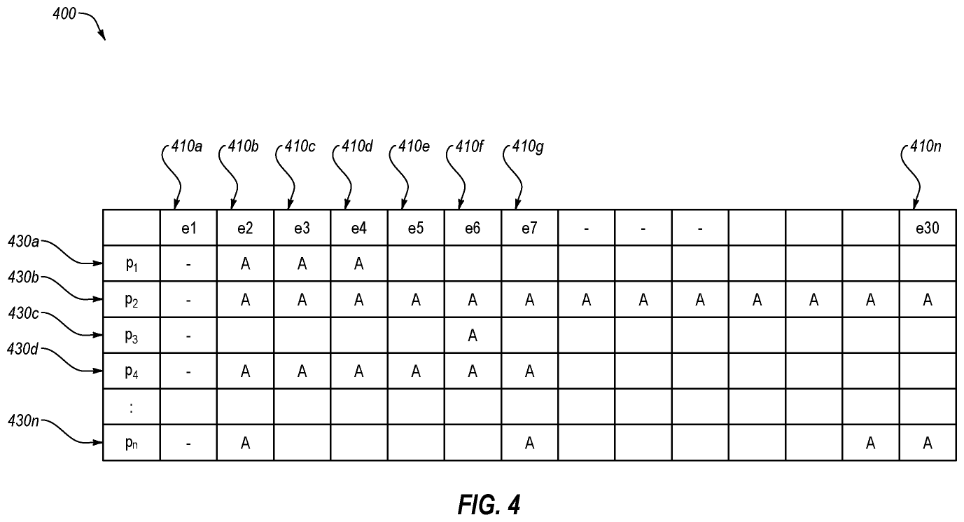

FIG. 4 is a table 400 that illustrates reducing training time of a DNN model. As depicted in FIG. 4, training a deep neural network model may occur during a period of thirty training epochs, 410a, 410b, 410c, 410d, 410e, 410f, 410g, and 410n (collectively the training epochs 410). The training data for the deep neural network model may include n training data points, 430a, 430b, 430c, 430d, and 430n (collectively the training data points 430). As depicted in the table 400, during each training epoch except the initial training epoch 410a, each of the training data points 430 may be augmented with variants of the training data points 430 (depicted as an “A” in the table). For example, during the second training epoch 410b, training data points 430a, 430b, 430d, and 430n may be determined as being not robust and may be augmented. Training data point 430c may be determined as being robust and may not be augmented. During successive training epochs 410, the training data points 430 may be augmented when the training data points 430 are determined as being not robust. In some embodiments, the robustness of particular training data points 430 may not be determined for a number of training epochs 410 after the particular training data points 430 are determined as being robust. For example, as depicted in the table 400, the robustness of training data point 430c may not be determined during training epochs 410c, 410d, and 410e because the training data point 430c was determined as being robust during training epoch 410b. Similarly, the robustness of training data point 430n may not be determined during training epochs 410d, 410e, and 410f because the training data point 430n was determined as being robust during training epoch 410c.

Modifications, additions, or omissions may be made to FIG. 4 without departing from the scope of the present disclosure. For example, the table 400 may include more or fewer elements than those illustrated and described in the present disclosure.

FIG. 5 is a flowchart of a first example method 500 of determining whether a training data point is being robust. At block 510, a training data point and a class for the training data point may be obtained. In some embodiments, the class may include a category of the training data point. For example, when the training data point is an image, the class may include a description of the image such as “cat,” “dog,” “person,” “car,” or other description.

At block 520, a predicted class threshold may be obtained. In some embodiments, the predicted class threshold may be a quantity of variants of the training data point that are correctly classified by the deep neural network model. At block 530, multiple variants of the training data point may be obtained. In these and other embodiments, the variants may include visual variants and/or audio variants depending on the type of the training data point. The visual variants may include rotations of the training data, translations of the training data, a shearing of the training data, zooming of the training data, changing a brightness of the first training data point, changing a contrast of the first training data point, and/or other variations of a training data point. The audio variants may include speed-based perturbations of speech in the training data, adding background noise to the training data, tempo-based perturbations of the training data, and/or other variations of a training data point.

At block 540, a predicted class determination may be performed with respect to each variant. In some embodiments, the predicted class determination may include determining a class prediction of the deep neural network model when provided each variant as an input. At block 550, a quantity of matching classes for the predicted class determinations may be determined. For example, fifty of the predicted class determinations may match the class for the training data point.

At decision block 560, the method 500 may determine whether the quantity of matching classes exceeds the predicted class threshold. In response to the quantity of matching classes exceeding the predicted class threshold (“Yes” at decision block 560), the method 500 may proceed to block 570, where the training data point is determined as being robust. In response to the quantity of matching classes not exceeding the predicted class threshold (“No” at decision block 560), the method 500 may proceed to block 580, where the training data point is determined as being not robust. The method 500 may return to block 510 after block 570 and block 580.

Modifications, additions, or omissions may be made to FIG. 5 without departing from the scope of the present disclosure. For example, the method 500 may include more or fewer elements than those illustrated and described in the present disclosure.

FIG. 6 is a flowchart of a second example method 600 of determining whether a training data point is being robust. At block 610, a training data point and a class for the training data point may be obtained. In some embodiments, the class may include a category of the training data point. For example, when the training data point is an image, the class may include a description of the image such as “cat,” “dog,” “person,” “car,” or other description.

At block 620, a loss threshold may be obtained. At block 630, multiple variants of the training data point may be obtained. In these and other embodiments, the variants may include visual variants and/or audio variants. The visual variants may include rotations of the training data, translations of the training data, a shearing of the training data, zooming of the training data, changing a brightness of the first training data point, changing a contrast of the first training data point, and/or other variations of a training data point. The audio variants may include speed-based perturbations of speech in the training data, adding background noise to the training data, tempo-based perturbations of the training data, and/or other variations of a training data point.

At block 640, a loss determination may be performed with respect to each variant. In some embodiments, the loss determination may include determining a loss of the deep neural network model when provided each variant as an input. Each loss may be determined based on a predicted probability that a predicted class of a variant matches the class for the training data point. At block 650, a maximum loss of the determined losses may be identified.

At decision block 660, the method 600 may determine whether the maximum loss is less than the loss threshold. In response to the maximum loss being less than the loss threshold (“Yes” at decision block 660), the method 600 may proceed to block 670, where the training data point is determined as being robust. In response to the maximum loss being greater than or equal to the loss threshold (“No” at decision block 560), the method 600 may proceed to block 680, where the training data point is determined as being not robust. The method 600 may return to block 610 after block 670 and block 680.

Modifications, additions, or omissions may be made to FIG. 6 without departing from the scope of the present disclosure. For example, the method 600 may include more or fewer elements than those illustrated and described in the present disclosure.

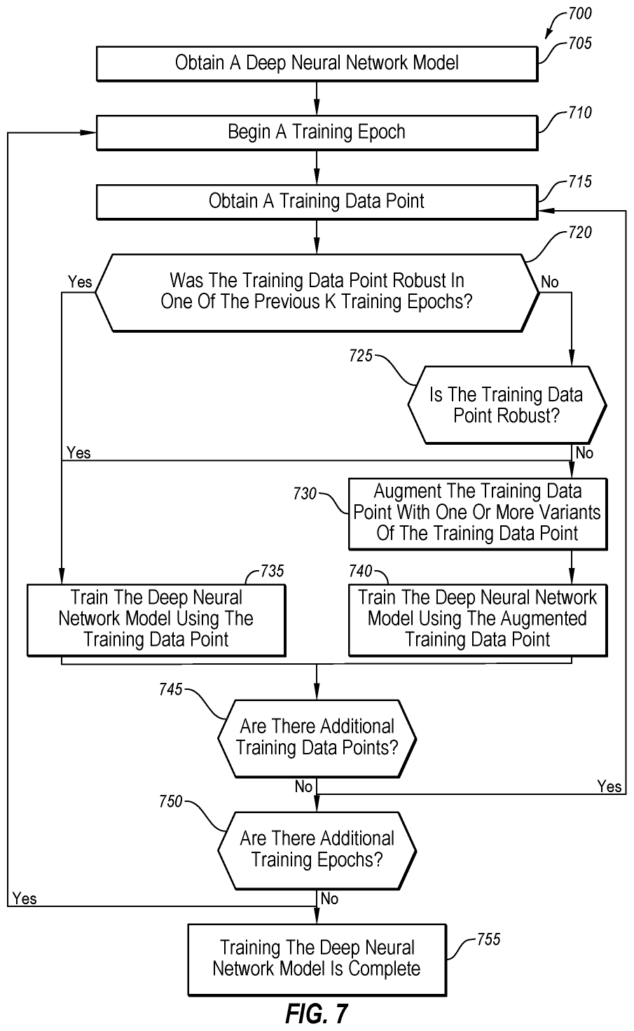

FIG. 7 is a flowchart of an example method 700 of training a deep neural network model. The method 700 may begin at block 705, where a deep neural network model may be obtained. At block 710, the method 700 may include beginning a training epoch. At block 715, a training data point may be obtained. At decision block 720, the method 700 may include determining whether the training data point was determined as being robust in one of the previous k training epochs. In some embodiments, “k” may represent any integer. For example, in some embodiments, k may be 0, 1, 2, 5, or any other number. Alternatively, in some embodiments, the method 700 may include determining whether the training data point was determining as being robust in a previous training epoch.

In response to the training data point being determined as being robust in one of the previous k training epochs (“Yes” at decision block 720), the method 700 may proceed to block 735. In response to the training data point being determined as being not robust in one of the previous k training epochs (“No” at decision block 720), the method 700 may proceed to block 725. At block 725, the method 700 may include determining whether the training data point is being robust. In some embodiments, the method 700 may employ a method similar to that discussed above with reference to FIGS. 5 and/or 6 to determine whether the training data point is being robust. Alternatively, in some embodiments, the method 700 may employ a different method to determine whether the training data point is being robust. In response to the training data point being determined as being robust (“Yes” at decision block 725), the method 700 may proceed to block 735. In response to the training data point being determined as being not robust (“No” at decision block 725), the method 700 may proceed to block 730.

At block 735, the training data point may be augmented with one or more variants of the training data point. At block 740, the deep neural network model may be trained using the augmented training data point. At block 735, the deep neural network model may be trained using the training data point. After block 735 or block 740, the method 700 may proceed to decision block 745. Training the deep neural network model may include a forward propagation and a backward propagation over the training data point and/or the augmented training data point. In some embodiments, the deep neural network model may be trained using an algorithm to minimize a cross-entropy loss function over the training data.

At decision block 745, the method 700 may determine whether there are additional training data points. In response to there being additional training data points (“Yes” at decision block 745), the method 700 may return to block 715. In response to there not being additional training data points (“No” at decision block 745), the method 715 may proceed to decision block 750. At decision block 750, the method 700 may determine whether there are additional training epochs. In response to there being additional training epochs, (“Yes” at decision block 750), the method 700 may return to block 710. In response to there not being additional training epochs (“No” at decision block 750), the method 700 may proceed to block 755. At block 755, training the deep neural network model may be complete.

Modifications, additions, or omissions may be made to FIG. 7 without departing from the scope of the present disclosure. For example, the method 700 may include more or fewer elements than those illustrated and described in the present disclosure.

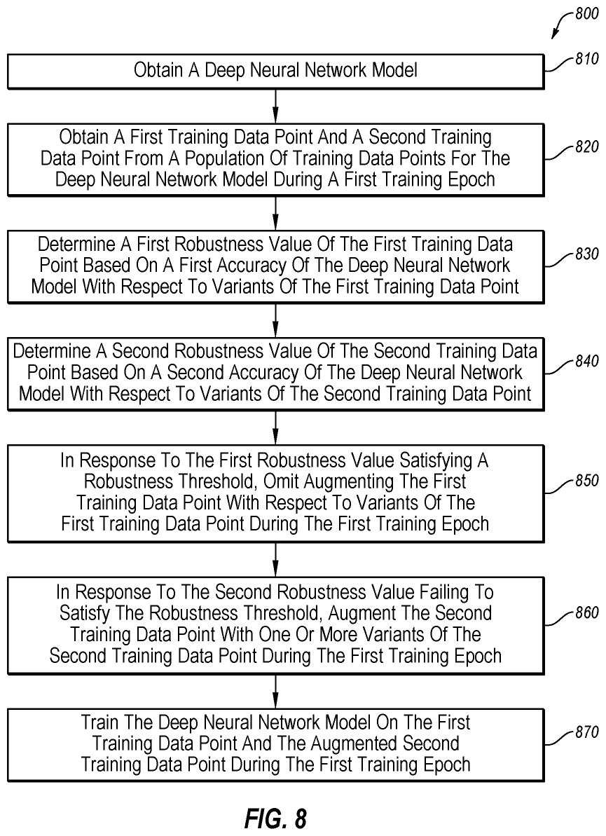

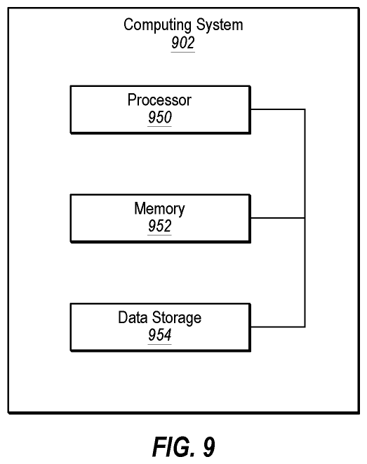

FIG. 8 is a flowchart of an example method of reducing the training time of a deep neural network model. The method 800 may be arranged in accordance with at least one embodiment described in the present disclosure. The method 800 may be performed, in whole or in part, in some embodiments, by a system and/or environment, such as the environment 100 and/or the computer system 902 of FIGS. 1 and 9, respectively. In these and other embodiments, the method 800 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 800 may being at block 810, where a deep neural network model may be obtained. In block 820, a first training data point and a second training data point may be obtained during a first training epoch from a population of training data points for the deep neural network model. In block 830, a first robustness value of the first training data point may be determined based on a first accuracy of the deep neural network model with respect to variants of the first training data point. In some embodiments, the deep neural network model may be determined to be accurate with respect to variants of the first training data point based on predicted class determinations, based on loss determinations, and/or based on another determination.

In some embodiments, the first robustness value may be determined based on a predicted class determination. In these and other embodiments, a class for the first training data may be obtained. The class may be a category of the first training data point. In these and other embodiments, multiple variants of the first training data point may be obtained. A predicted class determination may be performed with respect to each respective variant of the multiple variants. The predicted class determination may include determining a respective class prediction of the deep neural network model when provided each respective variant such that multiple class predictions are obtained with respect to the multiple variants. In these and other embodiments, the first robustness value may be determined as a quantity of matching classes of the multiple class predictions that match the obtained class for the first training data point.

In some embodiments, the first robustness value may be determined based on a loss determination. In these and other embodiments, a class for the first training data may be obtained. The class may be a category of the first training data point. In these and other embodiments, multiple variants of the first training data point may be obtained. A loss determination may be performed with respect to each respective variant of the multiple variants. The loss determination may be determined based on a predicted probability that a predicted class of the respective variant matches a class for the first training data point. In these and other embodiments, the first robustness value may be determined as a maximum loss of the one or more losses.

In block 840, a second robustness value of the second training data point may be determined based on a second accuracy of the deep neural network with respect to variants of the second training data point. In block 850, in response to the first robustness value satisfying a robustness threshold, the method 800 may include omitting augmenting the first training data point with respect to variants of the first training data point during the first training epoch. In some embodiments, the robustness threshold may include a predicted class threshold. Alternatively or additionally, in some embodiments, the robustness threshold may include a loss threshold.

In block 860, in response to the second robustness value failing to satisfy the robustness threshold, the second training data point may be augmented with one or more variants of the second training data point during the first training epoch. In block 870, the deep neural network model may be trained on the first training data point and the augmented second training data point during the first training epoch.

One skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments. In some embodiments, the method 800 may include additional blocks or fewer blocks. For example, in some embodiments, the method 800 may not include the second training data point and the associated blocks.

Alternatively or additionally, in some embodiments, the method 800 may include training the deep neural network model on the first training data point during one or more second training epochs after the first training epoch. In these and other embodiments, the method 800 may further include obtaining the first training data point from the population of training data points during a third training epoch after the one or more second training epochs. In these and other embodiments, the method 800 may also include determining a third robustness value of the first training data point based on a third accuracy of the deep neural network model with respect to variants of the first training data point. In these and other embodiments, the method 800 may further include augmenting the first training data point with one or more variants of the first training data point during the third training epoch in response to the third robustness value not satisfying the robustness threshold. In these and other embodiments, the method 800 may also include training the deep neural network model on the augmented first training data point during the third training epoch.

FIG. 9 illustrates a block diagram of an example computing system 902, according to at least one embodiment of the present disclosure. The computing system 902 may be configured to implement or direct one or more operations associated with an augmenting module (e.g., the augmenting module 170 of FIG. 1). The computing system 902 may include a processor 950, a memory 952, and a data storage 954. The processor 950, the memory 952, and the data storage 954 may be communicatively coupled.

In general, the processor 950 may include any suitable special-purpose or general-purpose computer, computing entity, or processing device including various computer hardware or software modules and may be configured to execute instructions stored on any applicable computer-readable storage media. For example, the processor 950 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 9, the processor 950 may include any number of processors configured to, individually or collectively, perform or direct performance of any number of operations described in the present disclosure. Additionally, one or more of the processors may be present on one or more different electronic devices, such as different servers.

In some embodiments, the processor 950 may be configured to interpret and/or execute program instructions and/or process data stored in the memory 952, the data storage 954, or the memory 952 and the data storage 954. In some embodiments, the processor 950 may fetch program instructions from the data storage 954 and load the program instructions in the memory 952. After the program instructions are loaded into memory 952, the processor 950 may execute the program instructions.

For example, in some embodiments, the DNN configuration module may be included in the data storage 954 as program instructions. The processor 950 may fetch the program instructions of the DNN configuration module from the data storage 954 and may load the program instructions of the DNN configuration module in the memory 952. After the program instructions of the DNN configuration module are loaded into memory 952, the processor 950 may execute the program instructions such that the computing system may implement the operations associated with the DNN configuration module as directed by the instructions.

The memory 952 and the data storage 954 may include computer-readable storage media for carrying or having computer-executable instructions or data structures stored thereon. Such computer-readable storage media may include any available media that may be accessed by a general-purpose or special-purpose computer, such as the processor 950. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 950 to perform a certain operation or group of operations.

Modifications, additions, or omissions may be made to the computing system 902 without departing from the scope of the present disclosure. For example, in some embodiments, the computing system 902 may include any number of other components that may not be explicitly illustrated or described.

As may be understood, identifying training data points of the deep neural network model 120 which may be benefitted by augmentation may be used as a means for improving existing deep neural network models 120 or reducing the training time of deep neural network models 120. Hence, the systems and methods described herein provide the ability to train and, in some instances, reduce the training time while improving the quality of deep neural network models and provide more accurate machine learning.

As indicated above, the embodiments described in the present disclosure may include the use of a special purpose or general purpose computer (e.g., the processor 950 of FIG. 9) including various computer hardware or software modules, as discussed in greater detail below. Further, as indicated above, embodiments described in the present disclosure may be implemented using computer-readable media (e.g., the memory 952 or data storage 954 of FIG. 9) for carrying or having computer-executable instructions or data structures stored thereon.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method comprising:
obtaining a deep neural network model;
obtaining a first training data point and a second training data point from a population of training data points for the deep neural network model during a first training epoch;
determining a first robustness value of the first training data point based on a first accuracy of the deep neural network model with respect to variants of the first training data point;
determining a second robustness value of the second training data point based on a second accuracy of the deep neural network model with respect to variants of the second training data point;
in response to the first robustness value satisfying a robustness threshold, omitting augmenting the first training data point with respect to variants of the first training data point during the first training epoch;
in response to the second robustness value failing to satisfy the robustness threshold, augmenting the second training data point with one or more variants of the second training data point during the first training epoch; and
training the deep neural network model on the first training data point and the augmented second training data point during the first training epoch.

2. The method of claim 1, wherein determining the first robustness value comprises:
obtaining a class for the first training data point, the class being a category of the first training data point;
obtaining, as the robustness threshold, a predicted class threshold;
obtaining a plurality of variants of the first training data point;
performing a predicted class determination with respect to each respective variant of the plurality of variants, the predicted class determination determining a respective class prediction of the deep neural network model when provided each respective variant such that a plurality of class predictions are obtained with respect to the plurality of variants;
determining, as the first robustness value, a quantity of matching classes of the plurality of class predictions that match the obtained class for the first training data point; and
in response to the quantity of matching classes satisfying the predicted class threshold, determining that the first training data point is robust, wherein omitting augmenting the first training data point is in response to determining that the first training data point is robust in response to the quantity of matching classes satisfying the predicted class threshold.

3. The method of claim 2, wherein obtaining the plurality of variants of the first training data point includes obtaining one or more random variants of the first training data point.

4. The method of claim 1, wherein determining the first robustness value comprises:
obtaining, as the robustness threshold, a loss threshold;
obtaining a plurality of variants of the first training data point;
performing a loss determination with respect to each respective variant of the plurality of variants, the loss determination determining a respective loss of the deep neural network model when provided each respective variant such that a plurality of losses are obtained with respect to the plurality of variants, each loss of the plurality of losses determined based on a predicted probability that a predicted class of the respective variant matches a class for the first training data point;
identifying, as the first robustness value, a maximum loss of the one or more losses; and
in response to the maximum loss satisfying the loss threshold, determining that the first training data point is robust, wherein omitting augmenting the first training data point is in response to determining that the first training data point is robust in response to the maximum loss satisfying the loss threshold.

5. The method of claim 1, wherein determining the first robustness value is based on a plurality of variants of the first training data point.

6. The method of claim 5, wherein the plurality of variants of the first training data point includes one or more visual variant types of a plurality of visual variant types comprising: a rotation of the first training data point; a translation of the first training data point; a shearing of the first training data point; a zooming of the first training data point; a changing of a brightness of the first training data point; and a changing of a contrast of the first training data point.

7. The method of claim 5, wherein the plurality of variants of the first training data point includes one or more audio variant types of a plurality of audio variant types comprising: a speed-based perturbation of speech in the first training data point; adding a background noise to the first training data point; and a tempo-based perturbation of the first training data point.

8. At least one non-transitory computer readable medium configured to store one or more instructions that, in response to being executed by at least one system, cause the at least one system to perform the method of claim 1.

9. A method comprising:
obtaining a deep neural network model;
obtaining a first training data point from a population of training data points for the deep neural network model during a first training epoch;
determining a first robustness value of the first training data point based on a first accuracy of the deep neural network model with respect to variants of the first training data point;
in response to the first robustness value satisfying a robustness threshold, omitting augmenting the first training data point with respect to variants of the first training data point during the first training epoch and during one or more second training epochs after the first training epoch;
training the deep neural network model on the first training data point during the first training epoch;
training the deep neural network model on the first training data point during the one or more second training epochs;
obtaining the first training data point from the population of training data points during a third training epoch after the one or more second training epochs;
determining a second robustness value of the first training data point based on a second accuracy of the deep neural network model with respect to variants of the first training point;
in response to the second robustness value not satisfying the robustness threshold, augmenting the first training data point with one or more variants of the first training data point during the third training epoch; and
training the deep neural network model on the augmented first training data point during the third training epoch.

10. The method of claim 9, wherein determining the first robustness value comprises:
obtaining a class for the first training data point, the class being a category of the first training data point;
obtaining, as the robustness threshold, a predicted class threshold;
obtaining a plurality of variants of the first training data point;
performing a predicted class determination with respect to each respective variant of the plurality of variants, the predicted class determination determining a respective class prediction of the deep neural network model when provided each respective variant such that a plurality of class predictions are obtained with respect to the plurality of variants;
determining, as the first robustness value, a quantity of matching classes of the plurality of class predictions that match the obtained class for the first training data point; and
in response to the quantity of matching classes satisfying the predicted class threshold, determining that the first training data point is robust, wherein omitting augmenting the first training data point is in response to determining that the first training data point is robust in response to the quantity of matching classes satisfying the predicted class threshold.

11. The method of claim 10, wherein obtaining the plurality of variants of the first training data point includes obtaining one or more random variants of the first training data point.

12. The method of claim 9, wherein determining the first robustness value comprises:
obtaining, as the robustness threshold, a loss threshold;
obtaining a plurality of variants of the first training data point;
performing a loss determination with respect to each respective variant of the plurality of variants, the loss determination determining a respective loss of the deep neural network model when provided each respective variant such that a plurality of losses are obtained with respect to the plurality of variants, each loss of the plurality of losses determined based on a predicted probability that a predicted class of the respective variant matches a class for the first training data point;
identifying, as the first robustness value, a maximum loss of the one or more losses; and
in response to the maximum loss satisfying the loss threshold, determining that the first training data point is robust, wherein omitting augmenting the first training data point is in response to determining that the first training data point is robust in response to the maximum loss satisfying the loss threshold.

13. The method of claim 9, wherein determining the first robustness value is based on a plurality of variants of the first training data point.

14. The method of claim 13, wherein the plurality of variants of the first training data point includes one or more visual variant types of a plurality of visual variant types comprising: a rotation of the first training data point; a translation of the first training data point; a shearing of the first training data point; a zooming of the first training data point; a changing of a brightness of the first training data point; and a changing of a contrast of the first training data point.

15. The method of claim 13, wherein the plurality of variants of the first training data point includes one or more audio variant types of a plurality of audio variant types comprising: a speed-based perturbation of speech in the first training data point; adding background noise to the first training data point; and tempo-based perturbation of the first training data point.

16. At least one non-transitory computer readable medium configured to store one or more instructions that, in response to being executed by at least one system, causes the at least one system to perform the method of claim 9.

17. A method comprising:
obtaining a deep neural network model;
obtaining a first training data point from a population of training data points for the deep neural network model during a first training epoch;
determining a first robustness value of the first training data point based on a first accuracy of the deep neural network model with respect to variants of the first training data point;
in response to the first robustness value satisfying a robustness threshold, omitting augmenting the first training data point with respect to variants of the first training data point during the first training epoch;
training the deep neural network model on the first training data point during the first training epoch.

18. The method of claim 17, wherein determining the robustness value comprises:
obtaining a class for the first training data point, the class being a category of the first training data point;
obtaining, as the robustness threshold, a predicted class threshold;
obtaining a plurality of variants of the first training data point;
performing a predicted class determination with respect to each respective variant of the plurality of variants, the predicted class determination determining a respective class prediction of the deep neural network model when provided each respective variant such that a plurality of class predictions are obtained with respect to the plurality of variants;
determining, as the first robustness value, a quantity of matching classes of the plurality of class predictions that match the obtained class for the first training data point; and
in response to the quantity of matching classes satisfying the predicted class threshold, determining that the first training data point is robust, wherein omitting augmenting the first training data point is in response to determining that the first training data point is robust in response to the quantity of matching classes satisfying the predicted class threshold.

19. The method of claim 17, wherein determining the robustness value comprises:
obtaining, as the robustness threshold, a loss threshold;
obtaining a plurality of variants of the first training data point;
performing a loss determination with respect to each respective variant of the plurality of variants, the loss determination determining a respective loss of the deep neural network model when provided each respective variant such that a plurality of losses are obtained with respect to the plurality of variants, each loss of the plurality of losses determined based on a predicted probability that a predicted class of the respective variant matches a class for the first training data point;
identifying, as the first robustness value, a maximum loss of the one or more losses; and
in response to the maximum loss satisfying the loss threshold, determining that the first training data point is robust, wherein omitting augmenting the first training data point is in response to determining that the first training data point is robust in response to the maximum loss satisfying the loss threshold.

20. At least one non-transitory computer readable medium configured to store one or more instructions that, in response to being executed by at least one system, cause the at least one system to perform the method of claim 17.
